(19) United States
(12) Patent Application Publication
(10) Pub. No.: US 2022/0183235 A1
(43) Pub. Date: Jun. 16, 2022

(54) METHOD, DEVICE AND USE OF VENTILATION SYSTEM FOR GROWING PLANTS

(71) Applicant: LogiCO2 International AB, Askim (SE)

(72) Inventor: Bo HANSSON, North Side (KY)

(21) Appl. No.: 17/118,263

(22) Filed: Dec. 10, 2020

(51) Int. Cl. A01G 9/24; A01G 9/18; A01G 22/15

(52) U.S. Cl. CPC A01G 9/246; A01G 22/15; A01G 9/18; A01G 9/249

(57) ABSTRACT

The invention relates to a ventilation system and method for promoting growth of a plant. The system comprises an air inlet provided at a first height from a defined floor level, an air outlet, fluidly connected to the inlet, an air moving device for moving air from the inlet to the outlet, and a plant growing surface, provided at a second height, being higher than the first height, for accommodating growing plants, wherein the air outlet is provided at a third height, being higher than the second height. The inventive concept is based on the inventors' realization that improved growing conditions can be provided by transporting CO₂ from the bottom of a lower level in a greenhouse to a higher level.

### BACKGROUND OF THE INVENTION

In order to optimize plant growth in a greenhouse, multiple parameters such as temperature, humidity and illumination needs to be considered. One of the more important parameters for promoting the growth of plants is presence of carbon dioxide (CO₂). As such, it is common to add CO₂ to the air of the greenhouse. This is often done by supplying the gas from separate canisters in which it is contained in concentrated form.

However, only adding CO₂ into the air may be problematic. Since the gas will not be readily mixed with the air, a major problem particularly arises for applications where the addition of CO₂ is controlled by some sort of feedback loop. An unmixed atmosphere will, when measuring the amount of CO₂, not provide a correct estimate of the final concentration of CO₂. As such, there is a high risk of over-shooting any target concentration.

An example of a common remedy to the above mentioned problem is the usage of fans. The fans are thus placed such that they promote good mixing of the air in the greenhouse. Often, they are placed on the ceiling, or close to the ceiling. However, the inventors have realized there are further improvement that may be done in this area.

### BRIEF SUMMARY OF THE INVENTION

An object of the present invention is thus to improve growing conditions in a greenhouse.

The invention is based on the inventors' realization that i) the fans used in state of the art technology pushes the air and CO₂ downwards, and that ii) since CO₂ is heavier (44 g/mol) compared to nitrogen (28 g/mol) and oxygen (16 g/mol) improved growing conditions can be provided by transporting gas from the bottom of a lower level in a greenhouse to a higher level.

According to a first aspect of the present invention, a ventilation system for promoting growth of a plant is provided. The system comprises an air inlet provided at a first height from a defined floor level, an air outlet, fluidly connected to the inlet, an air moving device for moving air from the inlet to the outlet, and a plant growing surface, provided at a second height, being higher than the first height, for accommodating growing plants, wherein the air outlet is provided at a third height, being higher than the second height.

The defined floor level is preferably the floor of a greenhouse in which the system is employed. As such, the air inlet is arranged at the floor level. Since carbon dioxide (CO₂) is heavier than both nitrogen and oxygen, it will fall towards the floor. Consequently, arranging an air inlet close to the floor level results in air with a higher concentration of CO₂ being transported to the outlet. The outlet, being arranged at a level higher than the plant growing surface, will then feed the CO₂-rich air to the plants. A high concentration of CO₂ promotes plant growth.

According to an exemplary embodiment, the ventilation system further comprises a controller for controlling the air moving device.

According to an exemplary embodiment, the ventilation system further comprises a light source arranged at a fourth height, being higher than the second height, wherein the controller is adapted to activate the air moving device upon activation of said light source.

Simultaneous activation may occur electronically, i.e. that switching on the light source simultaneously switches on the air moving device. Hereby, it is easy both to control the activation of the air device, but also to ocularly detect if the air moving device is active. Alternatively, a photocell may be arranged in the controller such that when the light source is activated, light from the light source reaches the photocell, and wherein the photocell, when sensing light from the light source, transmits a signal to the controller which, consequently, activates the air moving device. To this end, the controller may further comprise a translucent encapsulation behind which the photocell is arranged, such that the photocell is protected while still being able to receive light from the light source.

The controller may comprise any electrical control equipment capable of controlling the ventilation system including for example a fan engine, valves or other means for creating ventilation. The controller may comprise a user interface for adjusting settings of e.g. the flow amount, speed, timing and duration. The user interface may be digital or analogue. The user interface may also be handled from an external device, such as a mobile device. In a case where an external device is used for the user interface, the controller comprises a receiving means for receiving signals from said external device in order to control the ventilation system.

According to an exemplary embodiment, the ventilation system further comprises a CO₂ input for increasing the CO₂ level in the air to be supplied to the outlet, and a CO₂ controller for controlling the CO₂ input.

The CO₂ input may e.g. be arranged at the first height. Alternatively, the CO₂ input is arranged at the second height. Alternatively, the CO₂ input is arranged at a different height than the other features. The CO₂ controller may be incorporated into the controller for controlling the air moving device, such that a compact controller is provided. Alternatively, the CO₂ controller and the controller for controlling the air moving device are separate. The CO₂ controller and the controller for controlling the air moving device may be in communicative contact such that they are communicatively connected.

According to an exemplary embodiment, the ventilation system further comprises a CO₂ sensor for measuring CO₂, the CO₂ sensor being communicatively connected to the CO₂ controller.

In some embodiments, the CO₂ sensor is adapted to measure CO₂ at the second height. Alternatively, the CO₂ sensor may e.g. be arranged at the first height. Alternatively, the CO₂ input is arranged at a different height than the other features.

In some embodiments, the CO₂ sensor may be communicatively connected to the CO₂ controller. The CO₂ control unit may thereby be configured to add CO₂ to the CO₂ input if the CO₂ level is below a predetermined value.

According to an exemplary embodiment, the ventilation system further comprises a plurality of inlets and/or outlets for covering a larger area of a greenhouse.

According to a second aspect of the present invention, the use of a ventilation device according to the first aspect of the present invention for promoting growth of plants in a greenhouse is provided.

According to an exemplary embodiment, the plant is a cannabis plant.

According to a third aspect of the present invention, a method for promoting plant growth is provided, the method comprising: drawing in air with an air inlet provided at a first height from a defined floor level, transporting the air with an air moving device to an air outlet, fluidly connected to the inlet, wherein the air outlet is provided at a third height, being higher than the first height, and feeding the air towards a plant growing surface provided at a second height between the first height and the third height.

In the context of this application “the air is fed towards the plant” is to be understood as the air being fed into the atmosphere of a greenhouse in such a way so that the resulting movement of the air is towards the plant. As such, the air could be directly fed in the direction of the plant. Alternatively, the air could be indirectly fed to the plant e.g. be being fed in an upwards facing direction, with any redirecting means such as a ceiling or vent member, resulting in the air consequently moves towards the plant.

The defined floor level is preferably the floor of a greenhouse in which the system is employed. As such, the air is drawn in at the floor level. Since carbon dioxide (CO₂) is heavier than air, it will fall to the floor, and as such, air drawn in from the floor will have a higher concentration of CO₂, which is necessary for promoting plant growth.

According to an exemplary embodiment, the method further comprises the step of controlling the air moving device with a controller.

According to an exemplary embodiment, the method further comprises the steps of: measuring a first CO₂ level, preferably at the second height, comparing the first CO₂ level to a desired CO₂ level, and adding a first CO₂ injection to the air to be transported to the air outlet if the first measured level is below the desired level.

The desired CO₂ level does not have to be a discrete level, but may rather be an interval. The CO₂ level may e.g. be quantified in terms of concentration of CO₂ in the air. The desired level may also be dependent on where in the growth cycle the plants which are to be fed the air are in.

According to an exemplary embodiment, the method further comprises the steps of: measuring a second CO₂ level, subsequent to the step of adding the first CO₂ injection, and adding a second CO₂ injection to the air to be transported to the air outlet, if the second measured CO₂ level is still below the desired CO₂ level.

As such, if the CO₂ level does not reach the desired level after the first injection, a second injection is added. The dose of the first injection of CO₂ is preferably chosen to be low so that the concentration of CO₂ in the air is not overshot. Too high of a CO₂ concentration is detrimental to plant growth, e.g. by making water added to a plant acidic. As such, a method wherein CO₂ is added in a two-step process minimizes the risk for overshooting CO₂ concentration in the air.

In some embodiments, the desired CO₂ level is between 700 PPM and 2000 PPM. The desired CO₂ level may be different in different growth periods of the plants. For example, the desired CO₂ level is 700 PPM to 750 PPM, or 750 PPM to 800 PPM, or 1000 PPM to 1050 PPM, or 1050 PPM to 1100 PPM, or 1950 PPM to 2000 PPM.

According to an exemplary embodiment, the first CO₂ injection is performed during a time duration being different than a time duration during which the second CO₂ injection is performed.

The first CO₂ injection may e.g. be performed during a time duration being longer than the time duration during which the second CO₂ injection is performed. Hereby, the first injection may comprise more CO₂ than the section injection, so that the first injection brings the concentration close to the desired value and the second injection adjusts the concentration in a smaller degree.

According to an exemplary embodiment, the step of feeding the air towards the plant growing surface generates an air flow for creating a movement of plants placed on the plant growing surface.

Since the air is being fed continuously towards the plant, continuous movement is induced in the plant. For some plants, e.g. the cannabis plant, continuous movement of the plant body promotes plant growth. As such, the method according to the third aspect of the present invention improves plant growth by providing the plant with CO₂-rich air and by inducing movement in the plant.

According to an exemplary embodiment, the desired CO₂ level is dependent on the growth cycle.

Hereby, the CO₂ level can be adapted to specific conditions of the growth cycle having different needs of CO₂ level.

According to an exemplary embodiment, the first CO₂ injection is performed during a time duration corresponding to an addition of CO₂ that is estimated to bring the CO₂ level closer to the desired CO₂ level, but not all the way to the desired CO₂ level, such as 60%, 80% or 90% of the difference between the measured CO₂ level and the desired CO₂ level.

Hereby, the risk of overfeeding the greenhouse with CO₂ is reduced.

According to an exemplary embodiment, the second step of adding the CO₂ is conducted during a time duration calculated from the difference between the second measured CO₂ level and the desired CO₂ level, the difference between the first and second measured CO₂ level, and the duration of the first addition of CO₂.

Hereby, the second duration may be calculated based on the actual impact of the first addition of CO₂. As such, the system does not need initial information regarding the volume of the greenhouse, and thus, the method may be employed in a greenhouse of any volume.

According to an exemplary embodiment the method further comprising a step of waiting before conducting the step of measuring a second CO₂ level, so as to let the air mix with the CO₂ in the first CO₂ injection.

Hereby, the air is well mixed, e.g. by the ventilation system drawing air at the floor level and pushing it out in a higher level.

In the context of this application is should be understood that the device and methods are described in parallel and that features described in relation to the method may also be applicable to the device and vice versa.

### BRIEF DESCRIPTION OF THE DRAWINGS

These and other aspects of the present invention will now be described in more detail, with reference to the appended drawings showing exemplar embodiments of the present invention, wherein:

FIG. 1 illustrates a schematic side view of a greenhouse with a ventilation system according to some embodiments of the invention, and

FIG. 2 illustrates a flow-chart overview of a method according to some embodiments of the present invention.

### DETAILED DESCRIPTION OF THE INVENTION

In the following detailed description, some embodiments of the present invention will be described. However, it is to be understood that features of the different embodiments are exchangeable between the embodiments and may be combined in different ways, unless anything else is specifically indicated. Even though in the following description, numerous details are set forth to provide a more thorough understanding of the present invention, it will be apparent to one skilled in the art that the present invention may be practiced without these details. In other instances, well known constructions or functions are not described in detail, so as not to obscure the present invention.

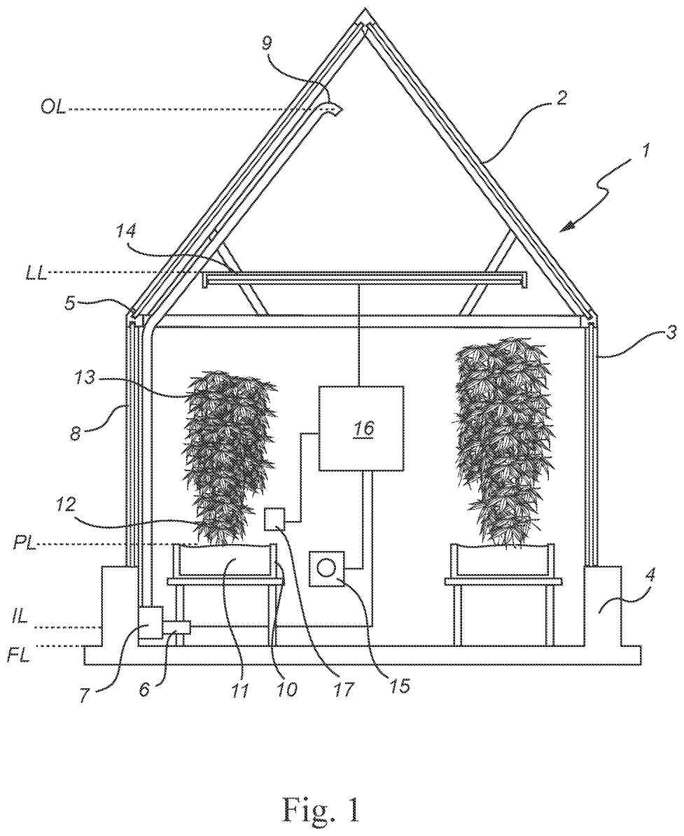

FIG. 1 shows a system 1 according to the first aspect of the present invention, wherein the system 1 is arranged in a greenhouse 2. The greenhouse 2 may be any conventional greenhouse of any size and made of any conventional material. Here, the greenhouse 2 comprises an outer structure 3 built upon a foundation 4. Furthermore, the greenhouse 2 is here not part of the system 1. In some embodiments, the greenhouse 2, or any part of the greenhouse, may comprise an integrated system 1 as described.

The system 1 comprises an air ventilation unit 5. The air ventilation unit 5 comprising an air inlet 6 for drawing in air from a floor level FL. The air inlet 6 is arranged at an inlet level IL above the floor level FL. The air inlet 6 is further connected to an air moving device 7 for moving the air drawn in by the air inlet 6. The air is moved by the air moving device 7 through a pipe 8 and to an air outlet 9. As such, the air outlet 9 is fluidly connected to the air inlet 6. The air outlet 9 is arranged at an outlet level OL. The outlet level OL is arranged above the floor level FL and the inlet level IL. The air outlet 9 is furthermore adapted to feed the air back into the greenhouse 2 and towards a plant 13. The air could be directly fed in the direction of the plant 13. Alternatively, the air could be indirectly fed to the plant 13 e.g. be being fed in an upwards facing direction, with any redirecting means such as a ceiling 2 a of the greenhouse 2 or vent member (not shown), or a flange (not shown) arranged in the ceiling 2 for redirecting air flow, resulting in the air consequently moves towards the plant 13.

The system 1 further comprises a plant bed 10 comprising soil 11, such that a plant growing surface 12 is arranged at a plant level PL. A plant 13 is accommodated in the plant bed 10 such that it is planted at the plant level PL. The plant level PL is arranged above the floor level FL, but below the outlet level OL. The plant 13 is here shown to be a cannabis plant. In other embodiments the plant 13 may be any other type of plant. For example, the plant 13 may be any plant that is commonly grown in a greenhouse, such as a tomato plant, a cucumber plant etc. Furthermore, the present invention is not limited to any number of plants 13.

The system 1 further comprises a light source 14 arranged at a light source level LL. The light source 14 is adapted to provide light to the plant 13. The light source 14 may e.g. be a UV-lamp adapted to provide light at least within an interval of wavelengths that promote plant growth. Here, the light source level LL is arranged above the floor level FL, above the plant level PL but below the outlet level OL. Alternatively, the light source level LL is arranged above the outlet level OL.

Here, the floor level FL is a defined floor level, the inlet level IL is arranged at a first height, the plant level PL is arranged at a second height and the outlet level OL is arranged at a third height.

The system 1 further comprises a CO₂ inlet 15 for providing CO₂ to the atmosphere of the greenhouse 2. Here, the CO₂ inlet is arranged close to the floor level FL, but it may be arranged at any height. However, placing the CO₂ inlet close to the floor level FL means that the air at the floor level FL will have, when the CO₂ inlet has added CO₂, a higher concentration of CO₂ than e.g. the air at the plant level PL. As such, when the CO₂ inlet has added CO₂ to the air at the floor level FL, such that the air at the floor level FL has a higher concentration of CO₂, the air inlet 6 of the ventilation device 5 draws in air with a higher concentration of CO₂ than if the CO₂ inlet would not have added CO₂.

The CO₂ inlet 15 is further connected to a controller 16. The controller 16 is in turn here shown to be connected to the air moving device 6 and the light source 14. As such, the controller 16 is adapted to control the CO₂ inlet, the air moving device 6 and the light source 14. Thus, a signal from the light source 14 may be received by the controller 16, whereupon the controller 16 activates or deactivates the air moving device 6. Alternatively, the controller 16 further comprises a photocell (not shown) adapted to receive light from the light source 14 such that it subsequently, upon receipt of the light, activates the air moving device 6. The controller 16 is further connected to a CO₂ sensor 17 for measuring a CO₂ level. Here, the CO₂ sensor 17 is arranged close to the plant level PL. As such, the CO₂ sensor 17 may provide the controller 16 with input data for controlling any other device in the system 1, such as the CO₂ inlet 15.

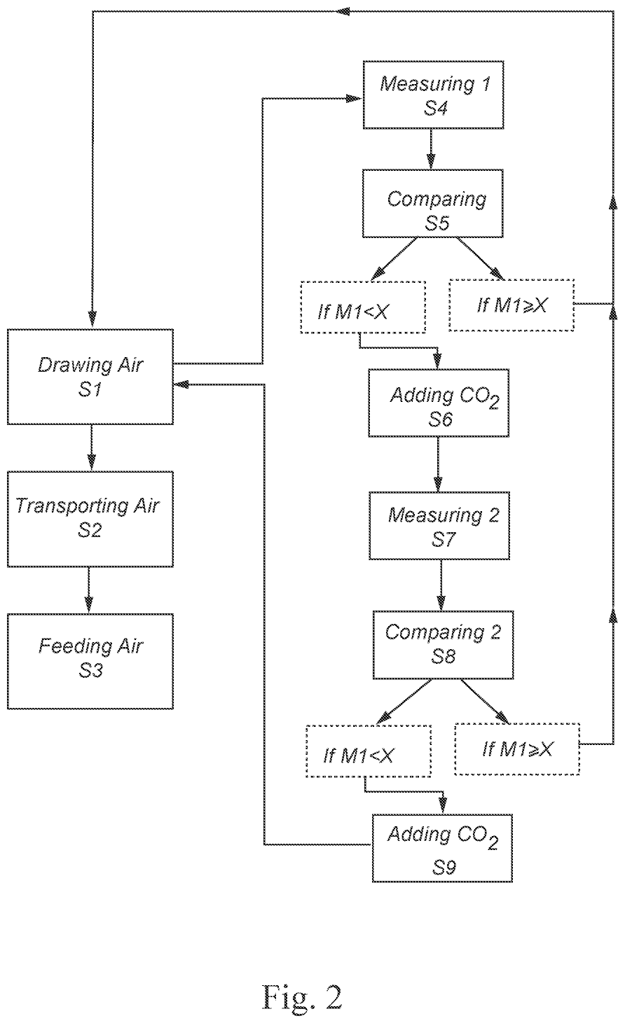

FIG. 2 schematically describes the steps in a method for promoting growth of a plant. The method comprises the major steps, namely S1 drawing in air with an air inlet provided at a first height from a defined floor level, S2 transporting said air with an air moving device to an air outlet, fluidly connected to said inlet. Moreover the air outlet is provided at a third height, being higher than said first height, and thirdly S3 feeding said air towards a plant growing surface provided at a second height between said first height and said third height. In some embodiments the step of feeding the air towards the plant growing surface generates an air flow for creating a movement of plants placed on the plant growing surface. This may be achieved by directing the outlet towards the plant growing surface, or e.g. by arranging an air guide element to guide the air towards the plant growing surface.

Although FIG. 2 illustrates that the optional steps S4-S9 as being connected to step 1 of drawing air, it should be understood that the method steps S4-S9 may well be performed in parallel with the steps S1-S3. In fact, it is possible the that optional steps S4-S9 are performed independently of steps S1-S3.

FIG. 2 further shows the optional step of measuring S4 a CO₂ level with a CO₂ sensor 17, preferably at the second height, e.g. the plant level PL. The step of S4 measuring is here a first measurement, such that the measured value M1 is a first determined value. After the first measuring S4 of a CO₂ level, the step of comparing S5 it to a desired level X is performed. The desired level X is e.g. provided as an input value into a controller 16 by an operator of a system according to the first aspect of the present invention. If M1<X, i.e. if the first measured value M1 is below the desired value X, a first CO₂ injection is added during the step of adding S6 a first CO₂ injection to the air to be drawn into the air inlet 6. If M1>X or if M1=X, i.e. if the first measured value M1 is larger than or equal to the desired value X, no CO₂ is added.

After the step of adding S6 CO₂ a second step of measuring S7 a CO₂ level is performed. Preferably, before conducting this second step of measuring S7 a waiting period should occur so as to let the air mix with the CO₂ that was injected in the first injection. The second measuring S7 provides a second measured value M2. Subsequently, the step of comparing S8 the second value M2 to the desired level X is performed. The desired level X may be the same in both steps of (S5, S8) comparing, but may alternatively be different. If M2<X, i.e. if the second measured value M2 is below the desired value X, a second CO₂ injection is added during the step of adding S9 a second CO₂ injection to the air to be drawn into the air inlet 6. If M2>X or if M2=X, i.e. if the second measured value M2 is larger than or equal to the desired value X, no CO₂ is added. It is to be understood that the method described is not limited to two respective steps of measuring, comparing and (optionally) adding CO₂, but may comprise further instances of any of these steps. As one example, if the measured level is lower than the desired level the measuring may be initiated again an infinite number of times.

In some embodiments, the step of adding the CO₂ may be dependent on the difference between the measured value and the desired value. E.g. if the concentration of CO₂ level in the air is only 50% of the desired value the CO₂ injection may have a duration of a first time duration, such as 20 seconds. Whereas if the CO₂ level in the air is about 80% of the desired value the CO₂ injection may have a duration of a second (shorter) time duration, such as 5 seconds. Thus, the time duration of the injection may be related to the difference between the measured value and the desired value.

In one embodiment, the first step of adding the CO₂ is conducted during a time duration relating to an amount of CO₂ corresponding to about 80% of difference between the measured CO₂ level and the desired CO₂ level. Hereby, the risk of adding too much CO₂ is reduced.

In one embodiment, the second step of adding the CO₂ is conducted during a time duration relating to both the difference between the measured CO₂ level and the desired CO₂ level and taking into consideration the actual increase of CO₂ concentration between the two most recent measurements and the most recent addition of CO₂ level. Hereby, the amount of CO₂ may be calculated based on previous learnings. As an example, the first measurement M1 corresponded to 30% of the desired CO₂ level X, and the first addition of CO₂ was conducted for time duration of 30 seconds. Thereafter the second measurement M2 shows a CO₂ level corresponding to 90% of the desired CO₂ level X. Then, the first addition that had a duration of 30 seconds resulted in an increase from 30% to 90% of the desired CO₂ level X, then the second addition could have a duration of 5 seconds to top up the CO₂ level to reach about 100% of the desired CO₂ level.

In some embodiments, the desired CO₂ level is dependent on the growth cycle of the plant or plants to which CO₂ is to be supplied. E.g. the desired level may be higher during some developments of the plant and lower during other development stages.

The invention has now been described with reference to specific embodiments. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting to the claim. The word “comprising” does not exclude the presence of other elements or steps than those listed in the claim. The word “a” or “an” preceding an element does not exclude the presence of a plurality of such elements.

1. Ventilation system for promoting growth of a plant, said system comprising,
an air inlet provided at a first height from a defined floor level,
an air outlet, fluidly connected to said inlet,
an air moving device for moving air from said inlet to said outlet, and
a plant growing surface, provided at a second height, being higher than said first height, for accommodating growing plants,
wherein
said air outlet is provided at a third height, being higher than said second height.

2. Ventilation system according to claim 1, further comprising a controller for controlling the air moving device.

3. Ventilation system according to claim 2, further comprising a light source arranged at a fourth height, being higher than said second height, wherein said controller is adapted to activate said air moving device upon activation of said light source.

4. Ventilation system according to claim 1, further comprising a CO₂ input for increasing the CO₂ level in the air to be supplied to the outlet, and a CO₂ controller for controlling the CO₂ input.

5. Ventilation system according to claim 4, further comprising a CO₂ sensor for measuring CO₂, said CO₂ sensor being communicatively connected to the CO₂ controller.

6. Ventilation system according to claim 5, wherein said sensor is adapted to measure CO₂ at said second height.

7. Ventilation system according to claim 1, further comprising a plurality of inlets and/or outlets for covering a larger area of a greenhouse.

8. Use of a ventilation device according to claim 1, for promoting growth of plants in a greenhouse.

9. Use of a ventilation device according to claim 8, wherein said plant is a cannabis plant.

10. Method for promoting growth of a plant, the method comprising:
drawing in air with an air inlet provided at a first height from a defined floor level,
transporting said air with an air moving device to an air outlet, fluidly connected to said inlet, wherein said air outlet is provided at a third height, being higher than said first height, and
feeding said air towards a plant growing surface provided at a second height between said first height and said third height.

11. Method according to claim 10 further comprising the step of controlling the air moving device with a controller.

12. Method according to claim 10, further comprising the steps of:
measuring a first CO₂ level, preferably at said second height,
comparing said first CO₂ level to a desired CO₂ level, and
adding a first CO₂ injection to the air to be transported to said air outlet if the first measured level is below the desired level.

13. Method according to claim 12, wherein said method further comprises the steps of:
measuring a second CO₂ level, subsequent to the step of adding the first CO₂ injection, and
comparing said second CO₂ level to said desired CO₂ level, and
adding a second CO₂ injection to the air to be transported to said air outlet, if the second measured CO₂ level is still below the desired CO₂ level.

14. Method according to claim 15, wherein the first CO₂ injection is performed during a time duration being different than a time duration during which the second CO₂ injection is performed.

15. Method according to claim 15, wherein the first CO₂ injection is performed during a time duration corresponding to an addition of CO₂ that is estimated to bring the CO₂ level closer to the desired CO₂ level, but not all the way to the desired CO₂ level, such as 60%, 80% or 90% of the difference between the measured CO₂ level and the desired CO₂ level.

16. Method according to claim 13, further comprising a step of waiting before conducting the step of measuring a second CO₂ level, so as to let the air mix with the CO₂ in the first CO₂ injection.

17. Method according to claim 15, wherein the second step of adding the CO₂ is conducted during a time duration calculated from:
the difference between the second measured CO₂ level and the desired CO₂ level,
the difference between the first and second measured CO₂ level, and
the duration of the first addition of CO₂.

18. Method according to claim 11, wherein the step of feeding said air towards the plant growing surface generates an air flow for creating a movement of plants placed on the plant growing surface.

19. Method according to claim 10, wherein the desired CO₂ level is dependent on the growth cycle of said plant.
